(19) United States
(12) Patent Application Publication
(10) Pub. No.: US 2026/0237197 A1
(43) Pub. Date: Aug. 13, 2026

(54) MULTI-ML (MACHINE LEARNING) MODEL SYSTEM WITH AN ADAPTIVE COMBINER FOR DIGITAL PATHOLOGY IMAGE PROCESSING

(71) Applicant: Ventana Medical Systems, Inc., Tucson, AZ (US)

(72) Inventors: Fariba Dambandkhameneh, Tucson, AZ (US); Nazim Shaikh, Tucson, AZ (US); Yao Nie, Tucson, AZ (US); Raghavan Venugopal, Tucson, AZ (US); Xiao Li, Tucson, AZ (US); Shakib Khan, Tucson, AZ (US)

(73) Assignee: Ventana Medical Systems, Inc., Tucson, AZ (US)

(21) Appl. No.: 19/450,988

(22) Filed: Jan. 16, 2026

Related U.S. Application Data
(60) Provisional application No. 63/757,701, filed on Feb. 12, 2025.

(51) Int. Cl. G06V 10/82; G06N 3/042; G06V 10/96; G06V 20/69

(52) U.S. Cl. CPC G06V 10/82; G06N 3/042; G06V 10/96; G06V 20/69

(57) ABSTRACT

The present disclosure relates to adaptively combining operations of multiple machine learning models, and using such multiple machine learning models to analyze digital pathology images. An image is processed using a first machine learning (ML) model, and a second ML model. A first weight and a second weight are generated, based at least in part on the image. A first output of the first ML model is weighted using the first weight, to generate a first weighted output. A second output of the second ML model is weighted using the second weight, to generate a second weighted output. The first weighted output and the second weighted output are combined, to generate a combined output. The combined output is processed, to generate a final output that is indicative of one or more inferences about the image.

### CROSS-REFERENCE TO RELATED APPLICATIONS

This application claims the benefit of U.S. Provisional Patent Application No. 63/757,701 filed on Feb. 12, 2025. The entire disclosure of the aforementioned application is incorporated by reference herein in its entirety for all purposes.

### BACKGROUND

Digital pathology is often used to guide a medical professional in diagnosis, prognosis and treatment assessment of a patient's disease. Stained biological samples (e.g., stained tissue slices) are mounted on glass microscope slides and are digitally imaged. A human pathologist or computational algorithm analyzes individual sections (referred to as patches) and characterizes cells in each patch. For example, it may be determined, for each patch, whether tumor cells are depicted in the patch, a quantity of tumor cells, a spatial distribution of tumor cells, etc. Such results can inform a diagnosis, treatment selection, treatment efficacy assessment, and so on.

Technological advances have enabled the digitization of histopathology slides into high-resolution images, providing opportunities to develop computer vision tools for a wide range of clinical applications. High-resolution, digital images of microscope slides make it possible to use computer-based analysis of slides. For example, machine learning models have shown promise as a tool in medical diagnostic applications and in predicting treatment outcomes.

In recent years, Artificial Intelligence has made significant progress and has achieved state-of-the-result in a variety of tasks from different domains/modalities. Much of this success comes from the availability of large training dataset and ever-increasing availability of different types of model(s) employed for histological image processing.

### SUMMARY

In various embodiments, a computer-implemented method comprises: processing an image using a first machine learning (ML) model; processing the image using a second ML model; generating a first weight and a second weight, based at least in part on the image; weighting a first output of the first ML model using the first weight, to generate a first weighted output; weighting a second output of the second ML model using the second weight, to generate a second weighted output; combining the first weighted output and the second weighted output, to generate a combined output; and processing the combined output, to generate a final output that is indicative of one or more inferences about the image. In an example, the first ML model is a graph neural network (GNN). In an example, the second ML model is a state space model (SSM). In an example, the second ML model is a Mamba model. In an example, the second ML model is a structured state space sequence model (S4).

In an example, generating the first weight and the second weight comprises: generating a sigmoid based on a combination of a first signal from the first ML model and a second signal from the second ML model; and generating at least one of the first weight or the second weight based on the sigmoid. In an example, the other of the first weight or the second weight is a function of the at least one of the first weight or the second weight. In an example, the sigmoid is applied to a sum or a weighted sum of the first signal and the second signal. In an example, the first signal and the second signal are intermediate feature representations generated by the respective ML models, or outputs of the respective ML models.

In an example, generating the first weight and the second weight comprises: implementing a gated fusion mechanism that dynamically adjusts relative contributions of the first ML model and the second ML model, based at least in part on intermediate feature representations generated by the respective ML models, or outputs of the respective ML models. In an example, generating the first weight and the second weight comprises: generating a first probability distribution based on the first output of the first ML model; generating a second probability distribution based on the second output of the second ML model; computing a first confidence score based on the first probability distribution; computing a second confidence score based on the second probability distribution; and generating at least one of the first weight or the second weight, based at least in part on the first confidence score and the second confidence score. In an example, generating the first probability distribution comprises using a softmax function to generate the first probability distribution, and wherein computing the first confidence score comprises computing predictive entropy of the first probability distribution. In an example, generating at least one of the first weight or the second weight comprises generating a ratio of the first confidence score relative to a combination of the first confidence score and the second confidence score. In an example, combining the first weighted output and the second weighted output comprises: summing, averaging, concatenating, or pooling the first weighted output and the second weighted output.

In various embodiments, a computer-program product comprises one or more non-transitory machine-readable storage media, including stored instructions configured to cause a computing system to perform a set of actions including: processing an image using a first machine learning (ML) model; processing the image using a second ML model; generating a first weight and a second weight, based at least in part on the image; weighting a first output of the first ML model using the first weight, to generate a first weighted output; weighting a second output of the second ML model using the second weight, to generate a second weighted output; combining the first weighted output and the second weighted output, to generate a combined output; and processing the combined output, to generate a final output that is indicative of one or more inferences about the image. In an example, the first ML model is a graph neural network (GNN) and the second ML model is one of a state space model (SSM), a Mamba model, or a structured state space sequence model (S4). In an example, generating the first weight and the second weight comprises: generating a first probability distribution based on the first output of the first ML model; generating a second probability distribution based on the second output of the second ML model; computing a first confidence score based on the first probability distribution; computing a second confidence score based on the second probability distribution; and generating at least one of the first weight or the second weight, based at least in part on the first confidence score and the second confidence score.

In various embodiments, a system comprises: one or more data processors; and a non-transitory computer readable storage medium containing instructions which, when executed on the one or more data processors, cause the one or more data processors to perform a set of actions including: processing an image using a first machine learning (ML) model; processing the image using a second ML model; generating a first weight and a second weight, based at least in part on the image; weighting a first output of the first ML model using the first weight, to generate a first weighted output; weighting a second output of the second ML model using the second weight, to generate a second weighted output; combining the first weighted output and the second weighted output, to generate a combined output; and processing the combined output, to generate a final output that is indicative of one or more inferences about the image. In an example, the first ML model is a graph neural network (GNN) and the second ML model is one of a state space model (SSM), a Mamba model, or a structured state space sequence model (S4). In an example, generating the first weight and the second weight comprises: implementing a gated fusion mechanism that dynamically adjusts relative contributions of the first ML model and the second ML model, based at least in part on intermediate feature representations generated by the respective ML models, or outputs of the respective ML models.

In various embodiments, a computer-program product tangibly embodied in a non-transitory machine-readable storage medium, includes instructions configured to cause one or more data processors to perform part or all of one or more methods disclosed herein.

In various embodiments, one or more means are to perform part or all of one or more methods disclosed herein.

In some embodiments, a system is provided that includes one or more data processors and a non-transitory computer readable storage medium containing instructions which, when executed on the one or more data processors, cause the one or more data processors to perform part or all of one or more methods disclosed herein.

In some embodiments, a computer-program product tangibly embodied in a non-transitory machine-readable storage medium, including instructions configured to cause one or more data processors to perform part or all of one or more methods or processes disclosed herein.

In some embodiments, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The present disclosure is described in conjunction with the appended figures:

FIG. 1 is a block diagram illustrating an example overview of a system performing processing of histopathology images, in accordance with an embodiment of the present disclosure.

FIG. 2 illustrates an exemplary network for generating a multiplex digital histopathology image, in accordance with an embodiment of the present disclosure.

FIG. 3 illustrates an example architecture of a system that includes two machine learning (ML) models for processing digital histopathology images, wherein outputs of the two ML models are adaptively combined and processed to generate a final output of the system of FIG. 3, in accordance with an embodiment of the present disclosure.

FIG. 4 illustrates the system of FIG. 3, and further illustrates examples of the two ML models of the system of FIG. 3, in accordance with an embodiment of the present disclosure.

FIG. 5A illustrates example implementations of one or more components of the systems of FIGS. 3 and 4 in further detail, in accordance with an embodiment of the present disclosure.

FIG. 5B illustrates an example implementation of an adaptive weighting coefficient generation module, in accordance with an embodiment of the present disclosure.

FIG. 6 shows an example flow chart of a computer-implemented method of adaptively combining operations of multiple machine learning models, and using such multiple machine learning models to analyze digital pathology images, in accordance with an embodiment of the present disclosure.

### DETAILED DESCRIPTION

In recent years, different types of machine learning (ML) models are being employed for various type of histological image processing. Each of these ML models have their respective advantages and disadvantages. Merely as an example, based on a nature or type of image being processed, a first ML model may relatively better at capturing first one or more aspects or attributes of the image, whereas a second ML model may relatively better at capturing second one or more aspects or attributes of the image.

Accordingly, techniques are described herein to implement a multi-ML model system, where two ML models are used to process digital histopathology images. For example, a first ML model generates a first output and a second ML model generates a second output. The first output from the first ML model and the second output from the second ML model are “adaptively” combined or fused, to generate a combined output. The final output and inference results of the multi-ML model system are based on this combined output.

Note that although the multi-ML model system is described below to include two ML models, the teachings of this disclosure may be extended to scenarios where more than two (such as three or higher) ML models may also be used, where outputs from such three or more ML models may be adaptively combined, to generate the final inference tasks.

As described above, the first output from the first ML model and the second output from the second ML model are “adaptively” combined. For example, the first output from the first ML model may be weighted by a first weight and the second output from the second ML model may be weighted by a second weight. The weighted first output and the weighted second output may then be combined (such as summed, averaged, or concatenated), to generate the combined output. By adaptively tuning the first and second weights, emphasis of each of the first ML model and the second ML model on the combined output may be controlled.

In an example, a sum of the first weight and the second weight may be equal to one (or another preconfigured value). Thus, once the first weight is adaptively generated or tuned, the second weight may be generated from the first weight, or vice versa.

The multi-ML model system may process a series of images, which may include, merely as an example, a first image and a second image. Also merely as an example, due to differences between the first and second images, assume that the first ML model may be relatively better suited to process the first image than the second ML model, and the second ML model may be relatively better suited to process the second image than the first ML model. Accordingly, when the first image is being processed by the multi-model ML system, during the adaptive output combination process, relatively more emphasis may be placed on the first output from the first ML model and relatively less emphasis may be placed on the second output from the second ML model. That is, the above-described first weight may be more than the second weight.

On the other hand, when the second image is being processed by the multi-model ML system, during the adaptive output combination process, relatively less emphasis may be placed on the first output from the first ML model and relatively more emphasis may be placed on the second output from the second ML model. That is, the above-described first weight may be less than the second weight.

Thus, in an example, by adaptively tuning the first and second weights, contributions of each of the first ML model and the second ML model on the final output of the multi-ML model system may be controlled.

Examples of the first ML model and the second ML model have been described herein below. In an example, the first ML model may be a graph neural network (GNN). In an example, the second ML model may be a state space model (SSM) based ML architecture, such as a Mamba model. Each of these models is described below in further detail. Note that while GNN and SSM (such as Mamba) are described as being examples of the first ML model and the second ML model, respectively, the teachings of this disclosure may be extended to cover one or more other ML models as well.

In an example, Mamba may relatively better capture short-range dependencies and long-range dependencies within the input image, e.g., thereby providing a comprehensive view of pathological patterns within the image. GNN, on the other hand, may focus on short dependencies within the image, e.g., thereby enhancing the analysis of relationships between neighboring tiles within the image. The capabilities of Mamba and GNN may be used by the multi-ML model system, e.g., based on the type of the image being processed.

Merely as an example, assume that the image includes one or more lesions (e.g., one or more tumor cells), and the multi-ML model system aims to identify the one or more lesions. In a first scenario, assume that the one or more lesions are on a relatively small area of the image and are neighboring each other. In such a case, short range dependencies are to be emphasized, where the output from GNN may be emphasized more than the output from Mamba, such that GNN may detect short range information associated with individual lesions, and Mamba may detect long dependencies between the lesions.

In contrast, in a second scenario, assume that the lesions are relatively apart from each other within the image. In such a case, short range dependencies may not be sufficient, as a GNN model may not capture information from distant nodes. In such an example, the output from Mamba may be emphasized more than the output from GNN (or both outputs may be emphasized somewhat similarly).

Thus, as described below in further detail, an adaptive weighting coefficient generation module dynamically and adaptively places emphasis on the Mamba and/or the GNN, e.g., by adjusting the first weight and the second weight, e.g., based on numbers and/or locations of lesions within the image. Operations of the adaptive weighting coefficient generation module (that generates or tunes the weights) have been described below in further detail. In an example, the adaptive weighting coefficient generation module applies sigmoid functions on outputs from the Mamba branch and the GNN branch processing the image, to generate at least one of the first weight or the second weight. In another example, the adaptive weighting coefficient generation module generates the first weight and the second weight, e.g., based on confidence information derived from probability distributions associated with outputs of the Mamba branch and the GNN branch. Thus, the first and second weights are based on outputs of the Mamba and GNN processing the image, and hence, the first and second weights are adaptively tuned based on the image being processed. Numerous examples, configurations, and embodiments are now described below in further detail.

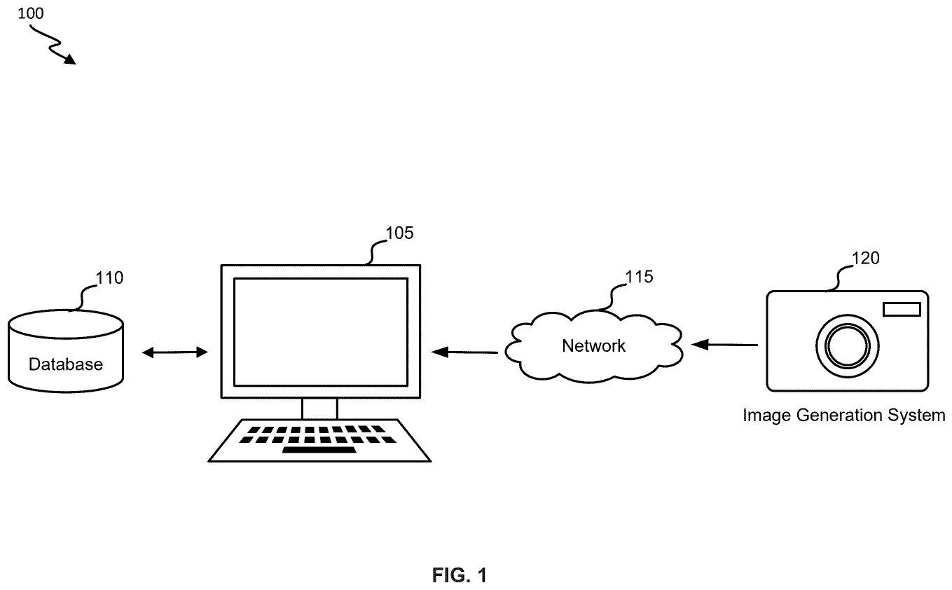

FIG. 1 is a block diagram illustrating an example overview of a system 100 performing processing of histopathology images, in accordance with an embodiment of the present disclosure. Merely as an example, the system 100 performs non-linear color demultiplexing of multiplex immunohistochemistry (IHC) based histopathology images. The exemplary system 100 may include one or more computer systems 105 connected with an image generation system 120 through a network 115. The system 100 may further include one or more databases 110 for the processing and storing of data (e.g., histopathology images). Database 110 may be integral to a memory system on the computer 105 or in secondary storage such as a hard disk, floppy disk, optical disk, or other non-volatile mass storage devices. The computer 105 and the databases 110 may be further connected to one or more communications networks 115. The computer 105 may include a client terminal in communication with one or more servers, or personal digital/data assistants (PDA), laptop computers, mobile computers, internet appliances, one or two-way pagers, mobile phones, or other similar desktop, mobile or hand-held electronic devices.

The computer system 105 of the exemplary system 100 includes a processing system with one or more Central Processing Unit(s) (“CPU”), one or more Graphic Processing Unit(s) (“GPU”), processors, and/or one or more memories. The computer system 105 may also include a memory for storing a plurality of processing modules or logical instructions that are executed by the one or more processors coupled. The computer memory that stores data may also be maintained on a computer readable medium including magnetic disks, optical disks, organic memory, and any other Volatile (e.g., Random Access Memory (“RAM)) or non-volatile (e.g., Read-Only Memory (“ROM), flash memory, etc.) mass storage system readable by the CPU. The computer readable medium includes cooperating or interconnected computer readable medium, which exist exclusively on the processing system or can be distributed among multiple interconnected processing systems that may be local or remote to the processing system.

The communications network 115 may include, internet, an intranet, a wired Local Area Network (LAN), a wireless LAN (WLAN), a Wide Area Network (WAN), a Metropolitan Area Network (MAN), Public Switched Telephone Network (PSTN) and other types of communications networks. The communications network 115 may include one or more gateways, routers, or bridges. The communications network 115 may include one or more servers and one or more web-sites accessible by users to send and receive information usable by the one or more computers 105. The one or more servers may also include one or more associated databases for storing electronic information. The communications network 115 includes, but is not limited to, data networks using the Transmission Control Protocol (TCP), User Datagram Protocol (UDP), Internet Protocol (IP) and other data protocols.

Besides processors and memory, the computer system 105 may also include user input and output devices such as a keyboard, mouse, stylus, and a display/touchscreen. For instance, the computer system 105 may provide a means for inputting image data from one or more scanned IHC slides to memory. Image data may include data related to color channels or frequency channels. A biological specimen, for example a tissue section, may need to be stained for biomarkers associated with chromogenic stains for brightfield imaging or fluorophores for fluorescence imaging. Staining assays can use chromogenic stains for brightfield imaging, or combinations of organic fluorophores, synthetic fluorophores, or quantum dots for fluorescence imaging. In the analysis of biological specimens, different stains may be specified to identify one or more types of biomarkers.

The term ‘sample’ may be understood as material derived from a biological organism, comprising but not limited to hair, skin samples, tissue samples, cultured cells, cultured cell media, and biological fluids. The term ‘tissue’ refers to a mass of interconnected cells (e.g., lung tissue, neural tissue, or eye tissue) derived from a human or other animal and includes the connecting material and the liquid material in association with the cells. In the context of histopathology, the term “slide” refers to a glass microscope slide carrying a thin section of tissue that has been stained for microscopic examination. The term ‘sample’ also includes media containing isolated cells. One skilled in the art may determine the quantity of samples required to obtain a reaction by standard laboratory techniques.

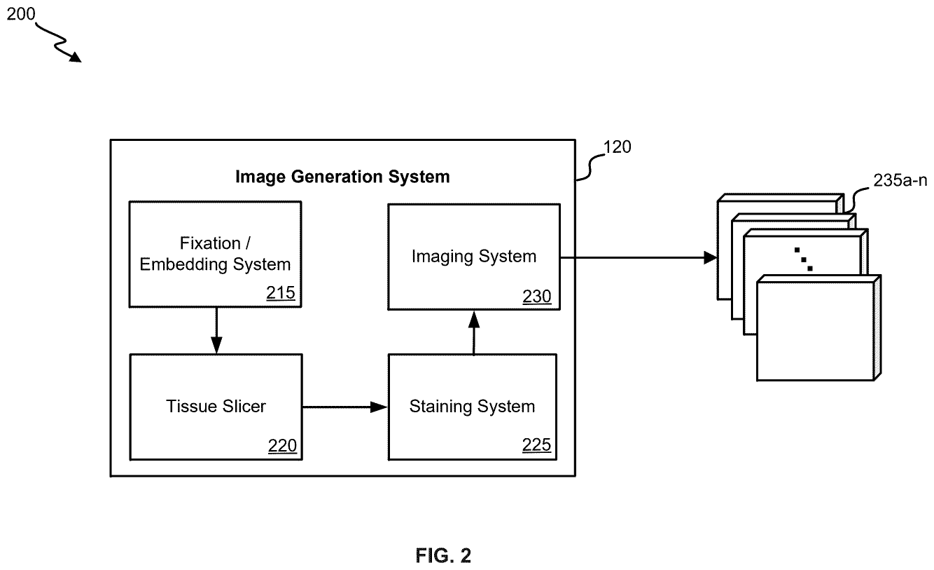

FIG. 2 shows an exemplary network of a digital pathology image generation system 200, in accordance with an embodiment of the present disclosure. Images are generated by an image generation system 120. A fixation/embedding system 215 fixes and/or embeds a tissue sample (e.g., a liquid fixing agent, such as formaldehyde solution) and/or an embedding substance (e.g., a historical wax, such as paraffin wax and/or one or more resins, such as styrene or polyethylene). Each slice may be fixed by exposing the slice to a fixating agent for a predefined period of time (e.g., at least 3 hours) and by then dehydrating the slice (e.g., via exposure to an ethanol solution and/or a clearing intermediate agent). The embedding substance can infiltrate the slice when it is in liquid state (e.g., when heated).

A tissue slicer 220 then slices the fixed and/or embedded tissue sample (e.g., a sample of a tumor) to obtain a series of sections, with each section having a thickness of, for example, 4-5 microns. Such sectioning can be performed by first chilling the sample and then slicing the sample in a warm water bath. The tissue can be sliced using (for example) a vibratome or compresstome.

Because the tissue sections and the cells within them are virtually transparent, preparation of the slides typically includes staining (e.g., automatically staining) the tissue sections to render relevant structures more visible. In some instances, the staining is performed manually. In some instances, the staining is performed semi-automatically or automatically using a staining system 225.

The staining can include exposing an individual section of the tissue to one or more different stains (e.g., consecutively, or concurrently) to reveal different characteristics of the tissue. For example, each section may be exposed to a predefined volume of a staining agent for a predefined period of time. The staining agent can include (for example) an RNA probe, protein probe (e.g., nuclear-protein probe or cytoplasm-protein probe), an immunohistochemistry stain, a probe for a secreted substance, etc. In some instances, the staining agent is one that stains for KAPPA mRNA or LAMBDA mRNA.

One exemplary type of tissue staining is histochemical staining, which uses one or more chemical dyes (e.g., acidic dyes, basic dyes) to stain tissue structures. Histochemical staining may be used to indicate general aspects of tissue morphology and/or cell microanatomy (e.g., to distinguish cell nuclei from cytoplasm, to indicate lipid droplets, etc.). One example of a histochemical stain is hematoxylin and eosin (H&E). Other examples of histochemical stains include trichrome stains (e.g., Masson's Trichrome), Periodic Acid-Schiff (PAS), silver stains, and iron stains. The molecular weight of a histochemical staining reagent (e.g., dye) is typically about 500 kilodaltons (kD) or less, although some histochemical staining reagents (e.g., Alcian Blue, phosphomolybdic acid (PMA)) may have molecular weights of up to two or three thousand kD. One case of a high-molecular-weight histochemical staining reagent is alpha-amylase (about 55 kD), which may be used to indicate glycogen.

Another type of tissue staining is immunohistochemistry (IHC, also called “immunostaining”), which uses a primary antibody that binds specifically to a target antigen of interest (biomarker). IHC may be direct or indirect. In direct IHC, the primary antibody is directly conjugated to a label (e.g., a chromophore or fluorophore). In indirect IHC, the primary antibody is first bound to the target antigen, and then a secondary antibody that is conjugated to a label (e.g., a chromophore or fluorophore) is bound to the primary antibody. The molecular weights of IHC reagents are much higher than those of histochemical staining reagents, as the antibodies have molecular weights of about 150 kD or more.

The sections may then be individually mounted on corresponding slides, which an imaging system 230 can then scan to generate raw multiplex digital-pathology images 235a-n. Each section may be mounted on a slide, which is then scanned to create a digital image that may be subsequently examined by digital pathology image analysis and/or interpreted by a human pathologist (e.g., using image viewer software). The imaging may include capturing bright-field images of the slide section.

In some instances, a pathologist or other expert may review and manually annotate the digital images of the slides (e.g., tumor area, necrosis, etc.). In some instances, annotation of regions of interest are performed automatically using a computer-vision technique. Some of the digital-pathology images 235a-n may be used by a color demultiplexing system 300.

A digital histopathology image (e.g., 235a) typically includes an array, usually a rectangular matrix, of pixels. Each ‘pixel’ is one picture element and is a digital quantity that is a value that represents some property of the image at a location in the array corresponding to a particular location in the image. Typically, in monochrome tone black and white images the pixel values represent a gray scale value. Pixel values for a digital image typically conform to a specified range. For example, each array element may be one byte (i.e., eight bits) representing pixel values in the range of 0 to 255. In a gray scale image, a 255 may represent absolute white and zero total black (or visa-versa). Color images consist of three-color planes, generally corresponding to red, green, and blue (RGB). For a particular pixel, there is one value for each of these color planes, (i.e., a value representing the red component, a value representing the green component, and a value representing the blue component). By varying the intensity of these three components, all colors in the color spectrum typically may be created.

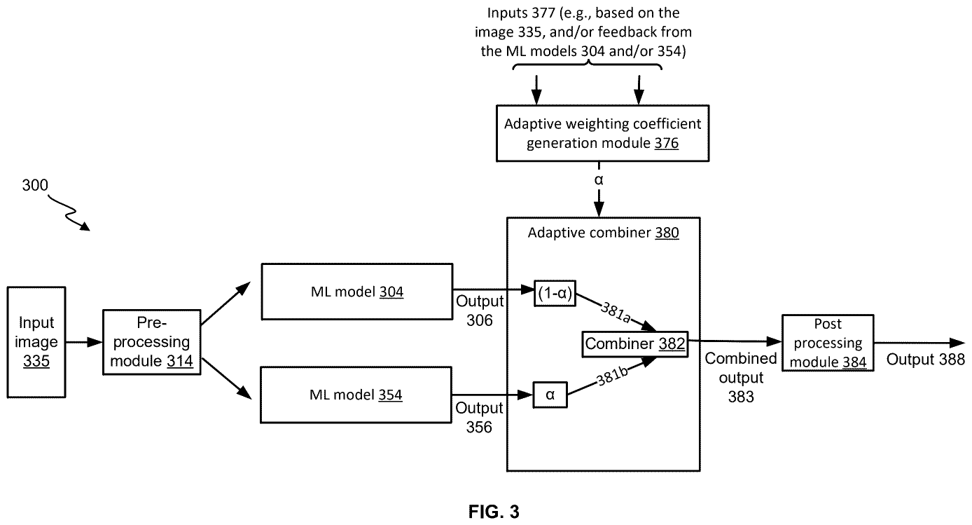

FIG. 3 illustrates an example architecture of a system 300 that includes two ML models 304 and 354 for processing digital histopathology images, wherein outputs of the two ML models 304, 354 are adaptively combined and processed to generate a final output 38 of the system 300, in accordance with an embodiment of the present disclosure. The system 300 receives an image 335, where the image 335 may be a digital histopathology image (such as a digital histopathology image described above). For example, the image 335 is a whole slide images (WSI) used in digital pathology.

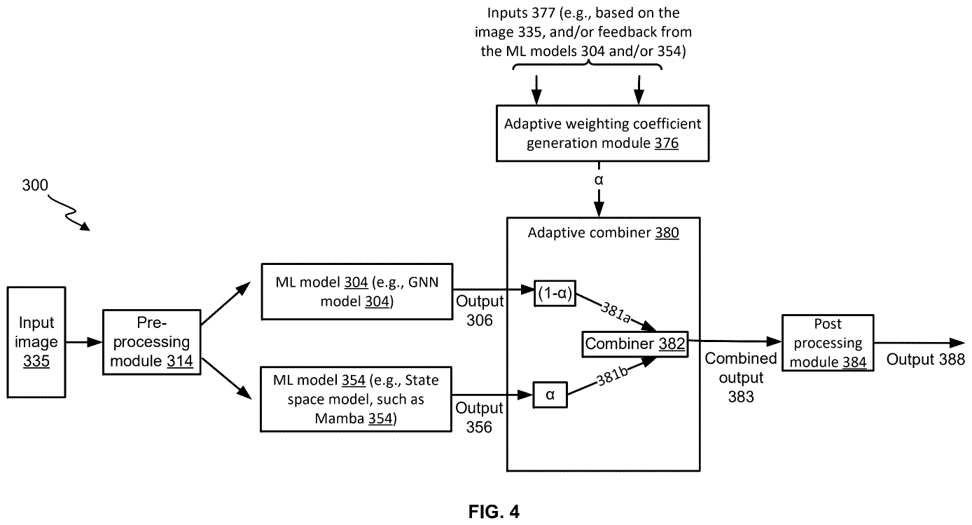

A pre-processing module 314 initially processes the image 335. An output of the pre-processing module 314 is provided to the ML models 304 and 354. The ML models 304 and 354 can be any appropriate type of ML models. For example, the ML model 304 may relatively better at capturing first one or more aspects or attributes of the image 335, whereas the ML model 354 may relatively better at capturing second one or more aspects or attributes of the image 335. Thus, the system 100 leverages on capabilities of both the ML models 304 and 354 in processing the image 335. Examples of ML models 304 and 354 are described below in further detail (e.g., with respect to FIG. 4).

The ML model 304 generates output 306 and the ML model 354 generates output 356. An adaptive combiner 380 combines the outputs 306 and 356, to generate a combined output 383. A post-processing module 384 processes the combined output 383, to generate a final output 388 of the system 300.

In an example, within the adaptive combiner 380, the output 306 is weighted by a weight (1−α) to generate a signal 381a, and the output 356 is weighted by a weight α to generate a signal 381b, where α is a weighting coefficient. Thus, a sum of the weights applied to the outputs 306 and 365 equals to one. However, in another example, sum of the weights applied to the outputs 306 and 365 may be another preconfigured or prespecified number, such as N (e.g., non-normalized sum). In such an example, the output 306 is weighted by a weight (N−α) to generate the signal 381a, and the output 356 is weighted by a weight α to generate the signal 381b. Although examples discussed herein assumes the sum of the weights to be one, teachings of this disclosure may be also applied to scenarios where the sum of the weights may be another preconfigured or prespecified positive number.

A combiner 382 combines the signals 381a, 381b, to generate a combined output 383 of the adaptive combiner 380. The combiner 382 may sum, average, or concatenate the signals 381a, 381b, to generate the combined output 383.

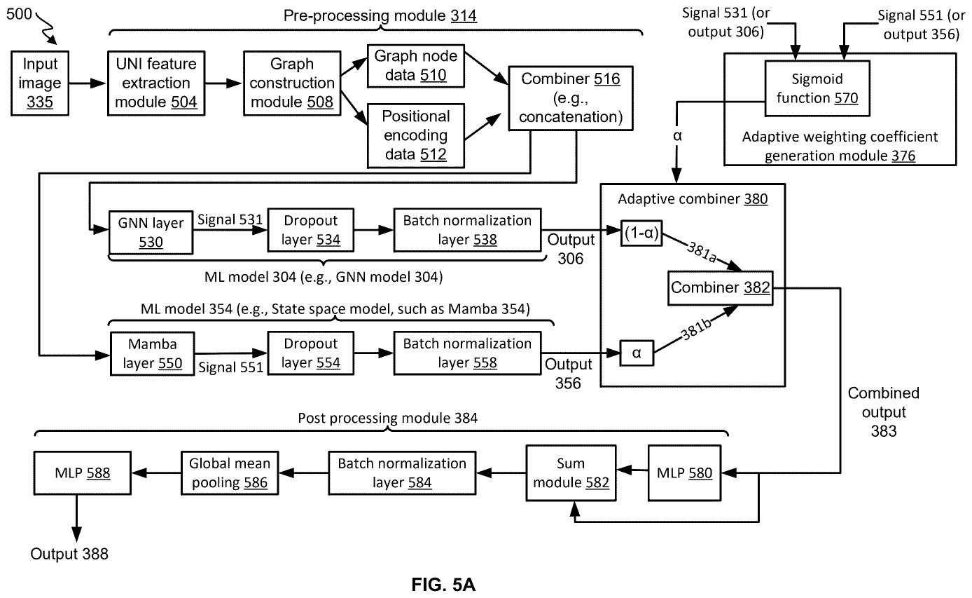

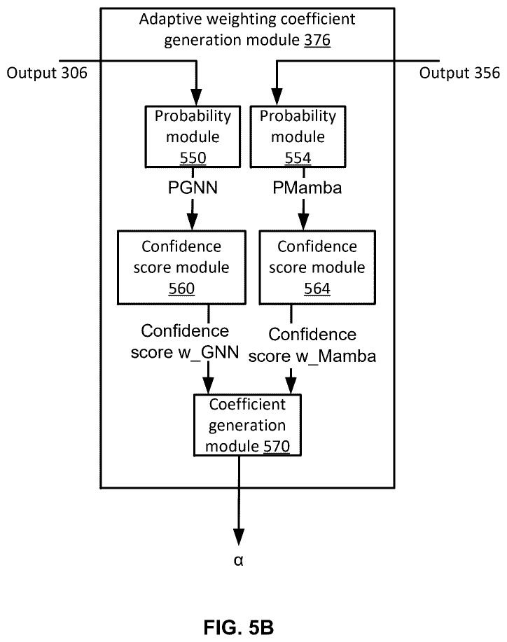

The adaptive combiner 380 is “adaptive” in the sense that the weighting coefficient α is adaptively generated, e.g., based on the image 335 being processed. For example, an adaptive weighting coefficient generation module 376 generates the weighting coefficient α, based on inputs 377. The inputs 377 may be based on the image 335, and/or feedback from the ML models 304 and/or 354, as described below in further detail (e.g., with respect to FIG. 5A). Thus, the weighting coefficient α is not a fixed or pre-configured number. Rather, the weighting coefficient α is generated adaptively, based on the image 335, thereby adaptively placing emphasis on the output 306 and/or the 356.

Merely as an example, if for a given image 335, the ML model 304 is relatively more suitable to process the image 335, the adaptive weighting coefficient generation module 376 generates the weighting coefficient α with a relatively lower value (e.g., such that (1−α) is higher than α), such that the output 306 is weighted by a relatively higher coefficient (1−α) than the weighting of the output 366 by a relatively lower coefficient α.

On the other hand, if for another given image 335, the ML model 354 is relatively more suitable to process the image 335, the adaptive weighting coefficient generation module 376 generates the weighting coefficient α with a relatively higher value (e.g., such that α is higher than (1−α)), such that the output 356 is weighted by a relatively higher coefficient than the output 306.

Thus, by adaptively generating the weighting coefficient α, the system 300 is able to place higher or lower emphasis (e.g., tune the emphasis) on the outputs 306 and/or 356, thereby adaptively controlling effects of the ML models 304 and/or 354 on the final output 388.

As described above, the ML models 304 and 354 can be any appropriate type of ML models. For example, the ML model 304 may relatively better at capturing first one or more aspects or attributes of the image 335, whereas the ML model 354 may relatively better at capturing second one or more aspects or attributes of the image 335. Thus, the system 100 leverages on capabilities of both the ML models 304 and 354 in processing the image 335, and adaptively places emphasis on one or both the ML models 304 and 354 (e.g., by adaptively controlling the weighting coefficient α).

FIG. 4 illustrates the system 300 of FIG. 3, and further illustrates examples of the two ML models 304 and 354 of the system 300 of FIG. 3, in accordance with an embodiment of the present disclosure.

As illustrated in FIG. 4, in an example, the ML model 304 is a graph neural network (GNN). GNNs are specialized artificial neural networks, in which inputs are in the form of graphs. GNNs are used for various applications where inputs can be represented as graphs. In an example, a characteristics of GNNs is the use of pairwise message passing, such that graph nodes iteratively update their representations by exchanging information with their corresponding neighbors.

As illustrated in FIG. 4, in an example, the ML model 354 is a state space model (SSM) based ML architecture. State space models are used in machine learning for time-series modeling, sequential decision-making, control tasks, and/or the like. SSMs provide a structured framework for representing dynamical systems, where the hidden states of the system evolve over time, e.g., based on previous states and external inputs.

Different types of SSMs are available. In an example, the SSM of the ML model 354 is Mamba, which is a deep learning architecture focused on sequence modeling. To enable handling long data sequences, Mamba incorporates a structured state space sequence model (S4). In an example, S4 may model long dependencies by combining continuous-time, recurrent, and convolutional models, e.g., which enables handling irregularly sampled data and unbounded context. Mamba adopts a unique selection mechanism that adapts structured state space model parameters based on the input, which enables Mamba to selectively focus on relevant information within sequences, effectively filtering out less pertinent data.

The ML model 304 is also referred to as GNN 304 herein, although the ML model 304 can be another type of ML model as well. The ML model 354 is also referred to as SSM 354 and/or Mamba 354 herein, although the ML model 354 can be another type of ML model as well.

In an example, the Mamba 354 may relatively better capture short-range dependencies and long-range dependencies within the image 335, e.g., thereby providing a comprehensive view of pathological patterns within the image. The GNN 304, on the other hand, may focus on short dependencies within the image, e.g., thereby enhancing the analysis of relationships between neighboring tiles within the image 335. The capabilities of Mamba 354 and GNN 304 may be used by the system 300, e.g., based on the type of the image.

Merely as an example, assume that the image 335 includes one or more lesions (e.g., one or more tumor cells), and the system 300 aims to identify the one or more lesions. In a first scenario, assume that the one or more lesions are on a relatively small area of the image 335 and are neighboring each other. In such a case, short range dependencies are to be emphasized, where the output 306 from the GNN 304 is emphasized more than the output 356 from the Mamba 354, where the GNN 304 may detect short range information associated with individual lesions, and the Mamba 354 may detect long dependencies between the lesions.

In contrast, in a second scenario, assume that the lesions are relatively apart from each other within the image 335. In such a case, short range dependencies may not be sufficient, as a GNN model may not capture information from distant nodes. In such an example, the output from the Mamba 354 may be emphasized more than the output from the GNN 304 (or both outputs may be emphasized somewhat similarly).

Thus, in this example, the adaptive weighting coefficient generation module 376 dynamically and adaptively places emphasis on the Mamba 354 and/or the GNN 304, e.g., by adjusting the weighting coefficient α, e.g., based on numbers and/or locations of lesions within the image.

In an example, the adaptive weighting coefficient generation module 376 and the adaptive combiner 380 enable a dynamic combiner mechanism to adaptively balance contributions from (i) the GNN 304, which is relatively better at modeling local and/or short-range dependencies, and (ii) the Mamba 354 (e.g., the state-space model), which captures global and/or long-range dependencies. For example, unlike a static combiner strategy (e.g., where output of Mamba and GNN are merely summed or average, without any adaptive weighting), the system 300 learns the context-dependent weighting coefficient α, to prioritize the GNN 304 and/or Mamba 354 that may be relatively more relevant to the features of the image 335 being processed.

Thus, the system 300 leverages combined capabilities of both GNN 304 and Mamba 354. For example, the system 300 primarily utilizes Mamba 354 for dual global and local feature extraction, and primarily employs GNN 304 to model local relationships for precise spatial analysis. This results in improved spatial analysis and classification accuracy in WSIs (such as the WSI image 335) by integrating local and global contextual information.

For example, to capture the long-range information within the image 335, the Mamba 354 is emphasized on, which is a state space model with linear time complexity, as described above. For example, the Mamba 354 has the capability to analyze how different areas of a slide or image 335 relate to each other, combining information from these areas to get a full understanding of the pathological context. In an example, WSIs (such as the image 335) generally demand significant computational resources due to their complexity. This complexity can become a challenge as computational demands increase. However, in an example, the Mamba 354 performs these computations efficiently, operating in linear time.

The GNN 304, as described above, receives graphs as its input. Accordingly, in an example, the WSI image 335 may be converted into a graph structure (e.g., using K-nearest neighbors (KNN), Delaunay triangulation, or another graph structure generation technique), where the graph structure defines node connectivity. The GNN 304 processes the constructed graph through a GNN architecture. Any GNN architecture may be used to perform feature extraction and analysis, such as a graph convolutional network (GCN), a graph attention network (GAT), graph isomorphism network convolution (GINConv), EdgeConv, and/or another GNN architecture.

Note that in an example, the GNN 304 may not be able to fully or satisfactorily capture information from distant nodes within the image 335 and/or distinguish differences between different patches. However, as described above, the Mamba 354 can aid in such tasks, in an example.

FIG. 5A illustrates example implementations of one or more components of the systems of FIGS. 3 and 4 in further detail, in accordance with an embodiment of the present disclosure.

As illustrated in FIG. 5A, the pre-processing module 314 comprises a UNI (unified message passing) feature extraction module 504 that processes the input image 335. UNI is a framework that improves operations of GNNs, e.g., by allowing for better aggregation and representation of node features. For example, UNI incorporates various node attributes and edge attributes for more expressive embeddings. The module 504 extracts UNI features from one or more (such as all) tiles or patches of the image 335.

A graph construction module 508 of the pre-processing module 314 receives output of the UNI feature extraction module 504, and facilitates in generation of a graph representation of the image 335. For example, to construct the graph from the features extracted by the UNI feature extraction module 504, a K-nearest neighbor (KNN) architecture is used for the graph construction module 508 (although other graph generation techniques may also be used in other examples).

The graph construction module 508 outputs graph node data 510 and positional encoding data 512. In an example, the graph node data 510 may be linearized. A combiner 516 combines the graph node data 510 and positional encoding data 512. For example, the combiner 516 concatenates the graph node data 510 and positional encoding data 512.

Output of the combiner 516 is selectively supplied to the GNN 304 and the Mamba 354. For example, adjacency matrix and features from the output of the combiner 516 are provided to the GNN 304, and features from the output of the combiner 516 are provided to the Mamba 354.

In an example, the GNN 304 comprises one or more GNN layers 530. The GNN layers 530 generate signal 531, which is processed by a dropout layer 534 and/or a batch normalization layer 538. The GNN 304 provides the output 306.

In an example, the Mamba 354 comprises one or more Mamba layers 550. The Mamba layers 550 generate signal 551, which is processed by a dropout layer 554 and/or a batch normalization layer 558. The Mamba 354 provides the output 356.

As described above, the outputs 306 and 356 are processed by the adaptive combiner 380, to generate a combined output 383. For example, the adaptive combiner 380 applies a weight (1−α) to the output 306 and a weight α to the output 356, and then combines the weighted outputs (such as sums, averages, or concatenates the weighted outputs).

The adaptive combiner 380 receives the weighting coefficient α from the adaptive weighting coefficient generation module 376. The adaptive weighting coefficient generation module 376 generates the weighting coefficient α, e.g., by applying a sigmoid function 570 to (i) the signal 531 (or to the output 306) from the GNN 304 and (ii) the signal 551 (or the output 356) from the Mamba 354. For example, the adaptive weighting coefficient generation module 376 implements a gated fusion mechanism in which the weighting coefficient α dynamically controls the relative contributions of the GNN 304 and the Mamba 354, e.g., based on characteristics of the image being processed. For example, the weighting coefficient α may be generated based on a relative informational content, suitability, and/or relevance of the respective outputs or intermediate representations produced by the GNN 304 and the Mamba 354 for a given input image. Thus, either the signal 531 or the output 306 may be used, and similarly, either the signal 551 or the output 356 may be used. The sigmoid function constrains the weighting coefficient α to a bounded range (e.g., between zero and one), which enables adjustment of the relative emphasis placed on the respective ML model outputs during training and/or inference, and acts as a soft attention mechanism and allows the system to adaptively prioritize one branch over the other based on the input image.

In an example, the sigmoid function 570 may determine a sigmoid of a sum of the signals 531 and 551. In another example, the sigmoid function 570 may determine a sigmoid of a weighted sum of the signals 531 and 551, where the weights applied to the signals 531 and 551 may be pre-configured and/or learned parameters. For example, when the input image 335 contains predominantly local or short-range information, the signal or output associated with the GNN 304 contributes more strongly to the generation of the weighting coefficient α, resulting in a relatively smaller α and a correspondingly larger (1−α), thereby placing greater emphasis on the output 306. Conversely, when the input image 335 contains predominantly global or long-range information, the signal or output associated with the Mamba 354 contributes more strongly to the generation of the weighting coefficient α, resulting in a relatively larger α and greater emphasis on the output 356. By computing the weighting coefficient α based on signals from both the GNN 304 and the Mamba 354, the adaptive weighting coefficient generation module 376 enables the system to assess the relative relevance of local spatial features captured by the GNN 304 and global or long-range contextual features captured by the Mamba 354. When the weighting coefficient α is closer to one, the output of the Mamba 354 is emphasized, and when the weighting coefficient α is closer to zero, the output of the GNN 304 is emphasized, thereby functioning as a soft attention or gating mechanism that adaptively selects between complementary inductive biases.

In an example, the weighting coefficient α may be generated using other gating or normalization functions in addition to, or instead of, a sigmoid function, such as a softmax function, a hyperbolic tangent function, a rectified linear unit followed by normalization, or a learned multilayer perceptron. Regardless of the specific gating or normalization function employed, the weighting coefficient α is generated so as to reflect a relative suitability of the respective ML models for processing the input image, and to adaptively increase or decrease emphasis on the output of the GNN 304 or the Mamba 354 accordingly.

The combined output 383 from the adaptive combiner 380 is processed by a multilayer perceptron (MLP) layer 580, and the output of the MLP layer 580 and the combined output 383 are summed at a sum module 582 (e.g., a skip connection is implemented from the adaptive combiner 380 to the sum module 582). An output of the sum module 582 is processed by a batch normalization layer 584, a global mean pooling layer 586, and/or another MLP layer 588, which generates the output 388.

FIG. 5B illustrates an example implementation of the adaptive weighting coefficient generation module 376, in accordance with an embodiment of the present disclosure. For example, FIG. 5A illustrates one example implementation of the adaptive weighting coefficient generation module 376, whereas FIG. 5B illustrates an alternate example implementation of the adaptive weighting coefficient generation module 376.

In the example of FIG. 5B, the weighting coefficient α is generated based on confidence scores derived from probability distributions associated with respective outputs 306 and 356 of the GNN 304 and the Mamba 354. As illustrated in FIG. 5B, the adaptive weighting coefficient generation module 376 receives the output 306 from the GNN 304 and the output 356 from the Mamba 354. The outputs 306 and 356 are provided to probability modules 550 and 554, respectively. The probability modules 550 and 554 are configured to generate respective probability representations PGNN and PMamba, for example by applying a softmax or other normalization function to the outputs of the respective ML models. The probability representations PGNN and PMamba may each comprise a plurality of probability values corresponding to different classes, categories, or inference outcomes.

The probability representations PGNN and PMamba are provided to respective confidence score modules 560 and 564. In an example, each confidence score module 560, 564 computes a confidence score based on predictive entropy of the corresponding probability representation. For example, the confidence score reflects a degree of certainty associated with the probability distribution output by the respective ML model, where a lower predictive entropy corresponds to a higher confidence score and a higher predictive entropy corresponds to a lower confidence score.

For example, the confidence score module 560 computes a confidence score w_GNN based on the predictive entropy of the probability representation PGNN generated from the output 306 of the GNN 304. Similarly, the confidence score module 564 computes a confidence score w_Mamba based on the predictive entropy of the probability representation PMamba generated from the output 356 of the Mamba 354. Thus, confidence scores w_GNN and w_Mamba are independently generated, and these scores reflect how confidently the respective model predicts one or more inference outcomes for the input image 335 that is being processed.

In an example, the confidence scores w_GNN and w_Mamba are provided to a coefficient generation module 570. The coefficient generation module 570 generates the weighting coefficient α based on a normalization of the confidence scores derived from the GNN 304 and the Mamba 354. In an example, the weighting coefficient α is generated as a ratio of the confidence score associated with the Mamba 354 relative to a combination of the confidence scores associated with the GNN 304 and the Mamba 354, as seen below in equation 1.

$$α = \frac{{w}_{\_ Mamba}}{{w}_{\_ Mamba} + {w}_{\_ GNN}} . \qquad Equation 1$$

For example, the weighting coefficient α reflects a relative contribution of the Mamba 354 with respect to the GNN 304.

In an example, the weighting coefficient α is generated on a per-image basis and dynamically adapts based on the confidence of the respective ML models for the image being processed. When PMamba exhibits lower predictive entropy than PGNN, the confidence score w_Mamba is relatively higher than w_GNN, resulting in a higher value of a and increased emphasis on the output 356 of the Mamba 354. On the other hand, when PGNN exhibits lower predictive entropy than PMamba, the confidence score w_GNN is relatively higher than w_Mamba, resulting in a lower value of a and increased emphasis on the output 306 of the GNN 304.

Accordingly, the operations illustrated in FIG. 5B enable the adaptive combiner 380 to weight the outputs 306 and 356 of the GNN 304 and the Mamba 354, respectively, based on entropy-based confidence information computed from probability representations generated by the respective ML models. Such adaptive weighting mechanism allows the system to dynamically emphasize the ML model that provides more confident predictions for a given image, thereby improving robustness and adaptability of the combined output.

Referring again to FIGS. 3-4, in an example, the multi-ML model system described above may be trained using a composite loss function designed to ensure discriminative performance and effective multi-scale fusion of outputs from the ML models 304 and 354. For example, a hinge loss may be employed, e.g., to cause a maximum-margin decision boundary. Hinge loss penalizes predictions based on their distance from the decision boundary, thereby concentrating gradient updates on hard or ambiguous images rather than on images that are already relatively well separated. Such a max-margin property may be particularly advantageous in computational pathology applications, where datasets may exhibit high intra-class heterogeneity and label noise, and where improved class separation may contribute to robustness against such variability.

In an example, the total training loss Lₜₒₜₐₗ is defined as a weighted sum of a fusion loss and auxiliary losses applied to individual branches of the multi-ML model system, as shown in Equation 2 below.

$${L}_{total} = {L}_{H i n g e ( {\hat{y}}_{f u s e d} , y )} + λ1 \cdot {L}_{H i n g e ( {\hat{y}}_{G N N} , y )} + λ2 \cdot L\_Hinge ( {\hat{y}}_{Mamba} , y ) \qquad Equation 2$$

The fusion loss Lₜₒₜₐₗ is computed using hinge loss applied to a fused prediction ŷ_{fused} generated from the adaptively combined outputs of the first and second ML models, while auxiliary hinge losses are computed for predictions ŷ_{GNN} and ŷ_{Mamba} generated by the respective ML models. Weighting factors λ₁ and λ₂ are pre-specified constants that control the relative contribution of the auxiliary losses, and in an example may each be equal to 0.5. In an example, the loss function jointly optimizes the fused prediction and the individual model branches, thereby encouraging effective multi-scale fusion while maintaining discriminative performance of each branch.

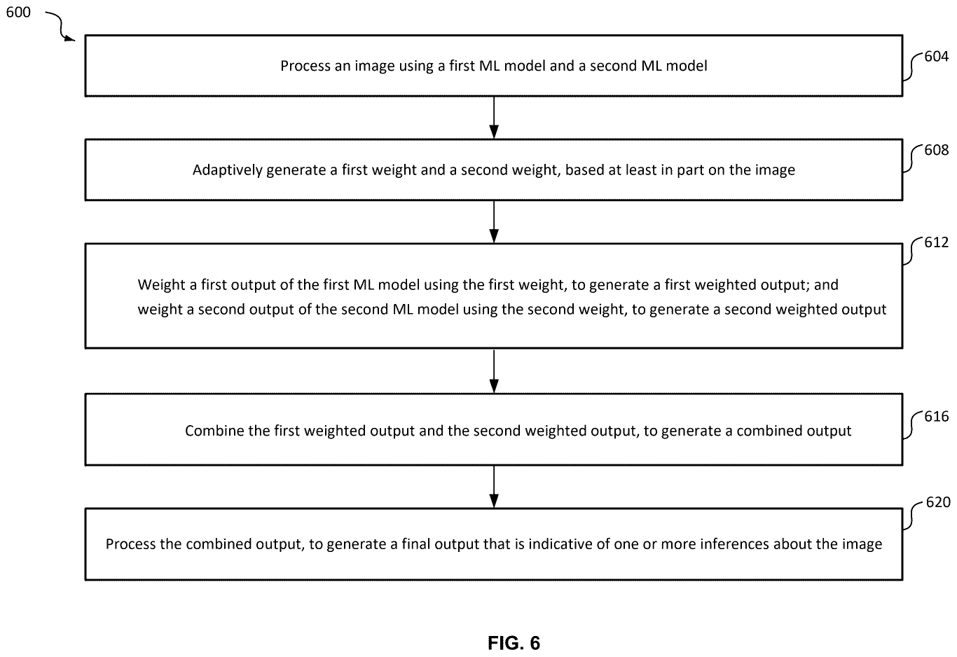

FIG. 6 shows an example flow chart of a computer-implemented method 600 of adaptively combining operations of multiple machine learning models, and using such multiple machine learning models to analyze digital pathology images, in accordance with an embodiment of the present disclosure.

At 604, an image (such as the input image 335 described above with respect to FIGS. 3-5) is processed using a first ML model (e.g., ML model 304) and a second ML model (e.g., ML model 354).

At 608, a first weight and a second weight are adaptively generated, based at least in part on the image. For example, the adaptive weighting coefficient generation module 376 generates the weights. In an example, the second weight is the weighting coefficient α, and the first weight is (1−α). Thus, the adaptive weighting coefficient generation module 376 may generate the second weight, and the adaptive combiner 380 may generate the first weight based on the second weight. Adaptive generation of the weighting coefficient α has been described above in further detail.

At 612, a first output of the first ML model is weighted using the first weight, to generate a first weighted output; and a second output of the second ML model is weighted using the second weight, to generate a second weighted output. For example, the adaptive combiner 380 weights the output 306 with the weight (1−α), and weights the output 356 with the weight α, as described above.

At 616, the first weighted output and the second weighted output are combined, to generate a combined output. For example, the combiner 382 combines the first and second weighted outputs (e.g., signals 381a, 381b), to generate the combined output 383, as described above in further detail.

At 620, the combined output is processed, to generate a final output that is indicative of one or more inferences about the image. For example, the post processing module 384 processes the combined output 383, to generate the final output 388 that is indicative of one or more inferences about the image 335.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

The present description provides preferred exemplary embodiments only, and is not intended to limit the scope, applicability or configuration of the disclosure. Rather, the present description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the present description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed is:

1. A computer-implemented method comprising:
processing an image using a first machine learning (ML) model;
processing the image using a second ML model;
generating a first weight and a second weight, based at least in part on the image;
weighting a first output of the first ML model using the first weight, to generate a first weighted output;
weighting a second output of the second ML model using the second weight, to generate a second weighted output;
combining the first weighted output and the second weighted output, to generate a combined output; and
processing the combined output, to generate a final output that is indicative of one or more inferences about the image.

2. The method of claim 1, wherein the first ML model is a graph neural network (GNN).

3. The method of claim 1, wherein the second ML model is a state space model (SSM).

4. The method of claim 1, wherein the second ML model is a Mamba model.

5. The method of claim 1, wherein the second ML model is a structured state space sequence model (S4).

6. The method of claim 1, wherein generating the first weight and the second weight comprises:
generating a sigmoid based on a combination of a first signal from the first ML model and a second signal from the second ML model; and
generating at least one of the first weight or the second weight based on the sigmoid.

7. The method of claim 6, wherein the other of the first weight or the second weight is a function of the at least one of the first weight or the second weight.

8. The method of claim 6, wherein the sigmoid is applied to a sum or a weighted sum of the first signal and the second signal.

9. The method of claim 6, wherein the first signal and the second signal are intermediate feature representations generated by the respective ML models, or outputs of the respective ML models.

10. The method of claim 1, wherein generating the first weight and the second weight comprises:
implementing a gated fusion mechanism that dynamically adjusts relative contributions of the first ML model and the second ML model, based at least in part on intermediate feature representations generated by the respective ML models, or outputs of the respective ML models.

11. The method of claim 1, wherein generating the first weight and the second weight comprises:
generating a first probability distribution based on the first output of the first ML model;
generating a second probability distribution based on the second output of the second ML model;
computing a first confidence score based on the first probability distribution;
computing a second confidence score based on the second probability distribution; and
generating at least one of the first weight or the second weight, based at least in part on the first confidence score and the second confidence score.

12. The method of claim 11, wherein generating the first probability distribution comprises using a softmax function to generate the first probability distribution, and wherein computing the first confidence score comprises computing predictive entropy of the first probability distribution.

13. The method of claim 11, wherein generating at least one of the first weight or the second weight comprises generating a ratio of the first confidence score relative to a combination of the first confidence score and the second confidence score.

14. The method of claim 1, wherein combining the first weighted output and the second weighted output comprises:
summing, averaging, concatenating, or pooling the first weighted output and the second weighted output.

15. A computer-program product comprising one or more non-transitory machine-readable storage media, including stored instructions configured to cause a computing system to perform a set of actions including:
processing an image using a first machine learning (ML) model;
processing the image using a second ML model;
generating a first weight and a second weight, based at least in part on the image;
weighting a first output of the first ML model using the first weight, to generate a first weighted output;
weighting a second output of the second ML model using the second weight, to generate a second weighted output;
combining the first weighted output and the second weighted output, to generate a combined output; and
processing the combined output, to generate a final output that is indicative of one or more inferences about the image.

16. The computer-program product of claim 15, wherein the first ML model is a graph neural network (GNN) and the second ML model is one of a state space model (SSM), a Mamba model, or a structured state space sequence model (S4).

17. The computer-program product of claim 15, wherein generating the first weight and the second weight comprises:
generating a first probability distribution based on the first output of the first ML model;
generating a second probability distribution based on the second output of the second ML model;
computing a first confidence score based on the first probability distribution;
computing a second confidence score based on the second probability distribution; and
generating at least one of the first weight or the second weight, based at least in part on the first confidence score and the second confidence score.

18. A system comprising:
one or more data processors; and
a non-transitory computer readable storage medium containing instructions which, when executed on the one or more data processors, cause the one or more data processors to perform a set of actions including:
processing an image using a first machine learning (ML) model;
processing the image using a second ML model;
generating a first weight and a second weight, based at least in part on the image;
weighting a first output of the first ML model using the first weight, to generate a first weighted output;
weighting a second output of the second ML model using the second weight, to generate a second weighted output;
combining the first weighted output and the second weighted output, to generate a combined output; and
processing the combined output, to generate a final output that is indicative of one or more inferences about the image.

19. The system of claim 18, wherein the first ML model is a graph neural network (GNN) and the second ML model is one of a state space model (SSM), a Mamba model, or a structured state space sequence model (S4).

20. The system of claim 18, wherein generating the first weight and the second weight comprises:
implementing a gated fusion mechanism that dynamically adjusts relative contributions of the first ML model and the second ML model, based at least in part on intermediate feature representations generated by the respective ML models, or outputs of the respective ML models.
